(19) United States
(12) Patent Application Publication
(10) Pub. No.: US 2012/0072573 A1
(43) Pub. Date: Mar. 22, 2012

(54) Systems for Balancing Brand Perception on Computer Network Information Sources

(75) Inventor: James M. Bladel, Le Claire, IA (US)

(73) Assignee: The Go Daddy Group, Inc., Scottsdale, AZ (US)

(21) Appl. No.: 12/886,551

(22) Filed: Sep. 20, 2010

(51) Int. Cl. G06F 15/173

(52) U.S. Cl. 709/224

(57) ABSTRACT

System of present invention comprises means for subscribing subscribers to a brand notification service, means for monitoring the computer network information sources for the brand mention, means for determining references located on the computer network information sources and containing the brand mention, means for scoring the references according to a predetermined scoring approach resulting in a brand mention score, means for determining whether the brand mention score is within a predetermined score range, and means for notifying the subscribers of the brand mention and supplying the subscribers with links to the references containing the brand mention.

### CROSS REFERENCE TO RELATED PATENT APPLICATIONS

This patent application is related to the following concurrently-filed patent application:

U.S. patent application Ser. No. ______, “Methods for Balancing Brand Perception on Computer Network Information Sources.”

The subject matter of all patent applications is commonly owned and assigned to The Go Daddy Group, Inc. All prior and concurrent applications are incorporated herein in their entirety by reference.

### FIELD OF THE INVENTION

The present invention relates in general to monitoring computer network information sources and publishing to computer network information sources.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

For Internet users and businesses alike, the Internet continues to be increasingly valuable. People are increasingly using the Web for everyday tasks such as social networking, shopping, banking, paying bills, and consuming media and entertainment. E-commerce is growing, with businesses delivering more services and content across the Internet, communicating and collaborating online, and inventing new ways to connect with each other.

Some Internet users, typically those that are larger and more sophisticated, may provide their own hardware, software, and connections to the Internet. But many Internet users either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

Websites may be created using HyperText Markup Language (HTML) to generate a standard set of tags that define how the webpages for the website are to be displayed. Users of the Internet may access content providers' websites using software known as an Internet browser, such as MICROSOFT INTERNET EXPLORER or MOZILLA FIREFOX. After the browser has located the desired webpage, it requests and receives information from the webpage, typically in the form of an HTML document, and then displays the webpage content for the user. The user then may view other webpages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

An individual or entities' domain name is increasingly the anchor around which their online presence is maintained. For example, a company's website (www.companyname.com) and email system (john.doe@companyname.com) utilize the company's domain name as an integral part of their architecture. Similarly, many Internet users use their email address, and therefore their domain name, as a means of identification on social websites, which have proliferated in recent years. Social websites are social networking services that focus on building and verifying online social networks for communities of people who share interests and activities, or who are interested in exploring the interests and activities of others, and which necessitates the use of software. Most social websites are Internet based and provide a collection of various ways for users to interact, such as chat, messaging, email, video, voice chat, file sharing, blogging, discussion groups, etc. The main types of social networking services are those which contain directories of some categories (such as former classmates), means to connect with friends (usually with self-description pages), and/or recommendation systems linked to trust. Popular methods now combine many of these, with MYSPACE, BEBO, FACEBOOK, YOUTUBE, LINKEDIN, and FLICKR being but a few examples.

Such social websites often post their members' public webpages for all Internet users to view, without authentication or login. Conversely, members' private webpages may only be accessed and viewed by the member. The private webpages generally require member authentication and provide the member with tools to manage his public webpage, communicate with other members, and/or otherwise manage his social website membership.

Many social websites, typically those that receive or share sensitive information (as well as websites associated with banks, credit card companies, and online businesses), may require Internet users to login to the website with a secure username and password before accessing the website's content.

The username/password system is a common form of secret authentication data used to control website access. The username/password is kept secret from those not allowed access. Those wishing to gain access are tested on whether or not they have a valid (recognized) username and whether they know the associated password. Internet users are granted or denied access to websites accordingly.

Many social websites have different rules governing the creation of usernames and passwords. Some require passwords that include a complex combination of letters, numbers, and other characters. Others have no restrictions whatsoever. With the proliferation of login-access websites, Internet users often must remember dozens (or more) different username/password combinations, one for each secure website they wish to access. This has resulted in what has come to be known as “password fatigue.”

Partly in response to these issues, the concept of the “digital identity” has evolved. A digital identity is a set of characteristics by which a person or thing is recognizable or distinguished in the digital realm. Digital identity allows for the electronic recognition of an individual or thing without confusing it for someone or something else.

There are many applications for an Internet user's digital identity, including authenticating the user before permitting access to a website. One method for such authentication includes the use of a URL (e.g., OpenID). URL-based digital identity systems (such as OPENID) utilize a framework based on the concept that any individual or entity can identify themselves on the Internet with a URL provided by a Digital Identity Provider (e.g., johndoe.openid.com). The Digital Identity Provider maintains an Identity Server on which a Digital Identity Database (a database of provided digital identity URLs and the corresponding authentication passwords) is stored.

Once obtained, the Internet user may utilize their digital identity URL to access various websites. For example, to login to an OpenID-enabled website, the user enters their OpenID (e.g., johndoe.openid.com) in the username box. The user is then momentarily redirected to the user's Digital Identity Provider's website (or an authentication window appears) to login using whatever password they have set up with their Digital Identity Provider. Once authenticated, the Digital Identity Provider sends the participating website an encrypted message (a token) confirming the identity of the person logging in. There are currently numerous Digital Identity Providers offering URL-based (OpenID) digital identity services, meaning they offer digital identity URLs and servers to authenticate them.

Many websites provide ability for a social commentary, including reviewing and rating businesses and their products. Applicant, however, has noticed that presently-existing systems and methods do not allow business owners to have a meaningful impact on the public perception of their brand formed due to reviews and ratings placed on the websites. For the foregoing reason, there is a need for the systems and methods that would allow business owners to have a meaningful impact on the public perception of their brand formed due to reviews and ratings placed on the websites.

Therefore, new systems and methods are needed to overcome the limitations of the current systems and methods.

### BRIEF DESCRIPTION OF THE DRAWINGS

FIG. 1 is a block diagram illustrating high-level components of an embodiment of a system of the present invention.

FIG. 2 is an interaction diagram illustrating interactions between the high-level components of a system of the present invention.

FIG. 3 is a flowchart illustrating an embodiment of a method of the present invention.

FIG. 4 is a block diagram illustrating an embodiment of a means-plus-function system of the present invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

For the purpose of this disclosure the term “brand owner” refers a commercial company, a non-profit organization, a governmental agency, a business operator, a business owner, a person, an entity, a management of an entity, a marketing specialist of an entity. The term “brand owner” also includes a person or entity acting on behalf of the above mentioned parties. Further, the term “brand owner” includes a computer system ran by above mentioned parties.

Some embodiments of the present invention allow brand owners or marketing managers to take a more active approach in countering criticism on the computer network information sources, such as, blogs, social networks, websites, etc.

It is now a commonplace for companies and brands to join social networks (e.g., FACEBOOK and TWITTER), in an effort to directly interact with their customer base. In general, actively involved customer base will consist of “fans” and “critics.” Fans are people who typically like the brand owner's products or services, and are interested in being associated with the brand for news, updates, and the general prestige involved with demonstrating loyalty. “Critics” are people who have had a negative experience with a brand owner's product or service, and want to use the computer network information sources to share their complaints.

While businesses should always engage critics in an attempt to better their services, there is a concern that a single disgruntled customer or former employee could cause a negative perception of the brand, and result in lost sales or diminished prestige of a brand. Even if the situation is resolved, some prospective customers may only see the public problem, as it appears on the computer network information sources, and ignore or miss the less public remedy.

The businesses may engage “fans” to balance the activities of “critics.” The engagement can be achieved through various mechanisms, such as, coupon codes, company's promotional merchandize, etc. One of the goals of some embodiments of the present invention is to supply the computer network information sources with post and commentary that helps to resolved the problems that some customers had with the brand owner products or services and counter-balance potential criticism.

To counteract the criticism on the computer network information sources, some embodiments of the present invention provide for strategically energizing business' or brand's fans or followers, and ask them to share their positive experience.

The invention provides a novel approach to the problem of leveraging the computer network information sources for commercial marketing purposes.

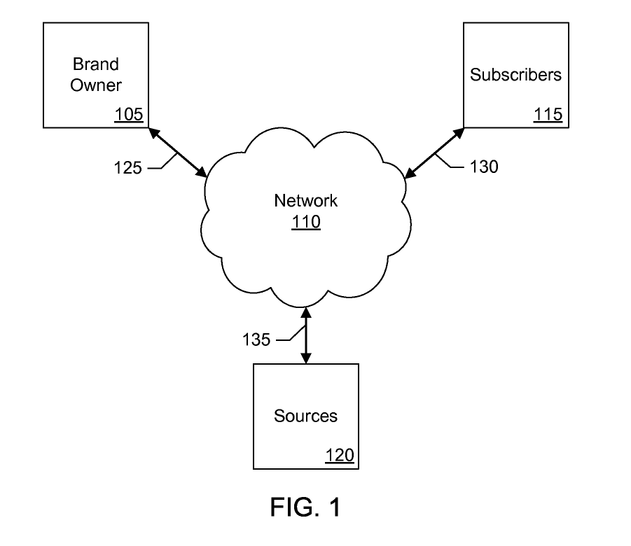

Referring to FIG. 1, an exemplary embodiment of the system of the present invention may include a Brand Owner 105 connectively coupled to a Network 110 via a first Communication Link 125, one or more Subscribers 115 connectively coupled to the Network 110 via a second Communication Link 130, and one or more Sources 120 (i.e., computer network information sources) connectively coupled to the Network 110 via a third Communication Link 135. The Brand Owner 105 is typically a business interested in protecting the reputation of its brand (or brand perception) on the Sources 120 using the Subscribers 115. The Subscribers 115 is one or more network users, who generally favor the brand of the Brand Owner 105. The Sources 120 include for example a website, a webpage, an online blog, a social network website, a product review website, a company review website, a commentary webpage, a feedback webpage, etc.

The Network 110 is a computer network. It may include a LAN (Local Area Network), WLAN (Wireless Local Area Network), WAN (Wide Area Network), MAN (Metropolitan Area Network), a global network, etc. The Internet is a widely-used global computer network. The Network 110 may support a variety of a network layer protocols, such as, DHCP (Dynamic Host Configuration Protocol), DVMRP (Distance Vector Multicast Routing Protocol), ICMP/ICMPv6 (Internet Control Message Protocol), IGMP (Internet Group Management Protocol), IP (Internet Protocol version 4), IPv6 (Internet Protocol version 6), MARS (Multicast Address Resolution Server), PIM and PIM-SM (Protocol Independent Multicast-Sparse Mode), RIP2 (Routing Information Protocol), RIPng for IPv6 (Routing Information Protocol for IPv6), RSVP (Resource ReSerVation setup Protocol), VRRP (Virtual Router Redundancy Protocol), etc. Further, the Network 110 may support a variety of a transport layer protocols, such as, ISTP (Internet Signaling Transport Protocol), Mobile IP (Mobile IP Protocol), RUDP (Reliable UDP), TALI (Transport Adapter Layer Interface), TCP (Transmission Control Protocol), UDP (User Datagram Protocol), Van Jacobson (compressed TCP), XOT (X.25 over TCP), etc. In addition, the Network 110 may support a variety of an application layer protocols, such as, COPS (Common Open Policy Service), FANP (Flow Attribute Notification Protocol), Finger (User Information Protocol), FTP (File Transfer Protocol), HTTP (Hypertext Transfer Protocol), IMAP and IMAP4 (Internet Message Access Protocol, rev 4), IMPPpre (Instant Messaging Presence Protocol), IMPPmes (Instant Messaging Protocol), IPDC (IP Device Control), IRC (Internet Relay Chat Protocol), ISAKMP (Internet Message Access Protocol version 4rev1), ISP, NTP (Network Time Protocol), POP and POP3 (Post Office Protocol, version 3), Radius (Remote Authentication Dial In User Service), RLOGIN (Remote Login), RTSP (Real-time Streaming Protocol), SCTP (Stream Control Transmission Protocol), S-HTTP or HTTPS (Secure Hypertext Transfer Protocol), SLP (Service Location Protocol), SMTP (Simple Mail Transfer Protocol), SNMP (Simple Network Management Protocol), SOCKS (Socket Secure Server), TACACS+ (Terminal Access Controller Access Control System), TELNET (TCP/IP Terminal Emulation Protocol), TFTP (Trivial File Transfer Protocol), WCCP (Web Cache Coordination Protocol), X-Window (X Window), etc. The Network 110 supports digital interactions between the Brand Owner 105, the Subscribers 115, and the Sources 120.

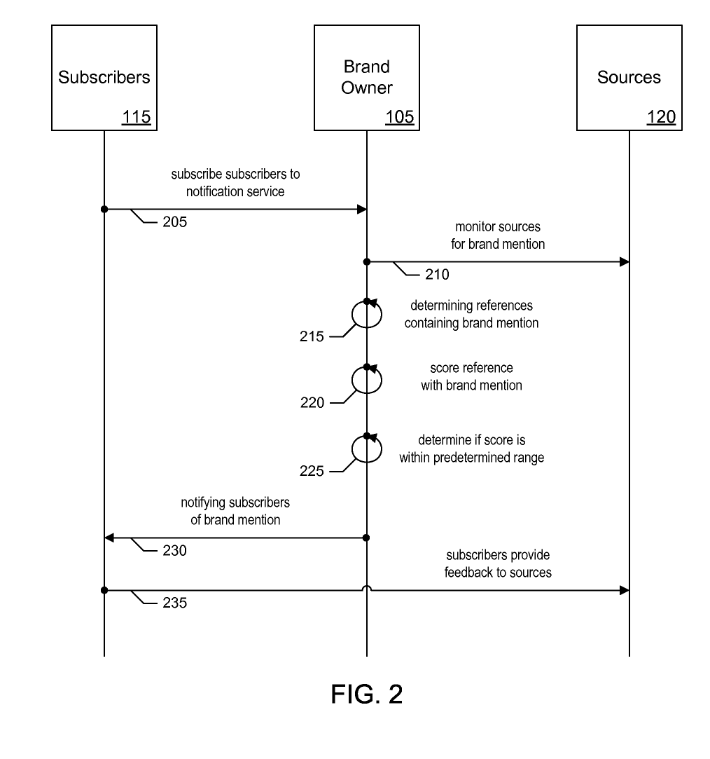

An exemplary embodiment of interactions between the system components is shown in FIG. 2. The Brand Owner 105 is subscribing the Subscribers 115 to a brand notification service (step 205). In a preferred embodiment the subscription is enabled via a web-based graphical user interface. The Brand Owner 105 monitors the Sources 120 for a mentioning of a brand (step 210). If the brand is mentioned, the Brand Owner 105 determines the references located on the Sources 120, which contain the brand mention (step 215). The Brand Owner 105 then scores the references (step 220) and determines whether the brand mention score is within a predetermined score range (step 225). If the score is within the predetermined score range, then the Brand Owner 105 notifies the Subscribers 115 of the brand mention and supplies the Subscribers 115 with the links to the references containing brand mention (step 230). The Subscribers 115 may then provide a feedback to the Sources 120 to counter-balance the brand perception.

If the subscription is enabled via a web-based graphical user interface, the web-based graphical user interface is typically a website or a webpage. The web-based graphical user interface is achieved by a first computer-readable code on the Brand Owner 105 server computer and by a second computer-readable code on the Subscribers 115 desktop/remote computers. The first computer-readable code may comprise, for example, SGML, HTML, DHTML, XML, XHTML, CSS, server-side programming languages and scripts, such as, Perl, PHP, ASP, ASP.NET, Java, JavaScript, Visual J++, J#, C, C++, C#, Visual Basic, VB.Net, VBScript, server-side databases, etc. The second computer-readable code may comprise, for example, SGML (Standard Generalized Markup Language), HTML (HyperText Markup Language), DHTML (Dynamic HTML), XML (eXtensible Markup Language), XHTML (eXtensible HTML), CSS (Cascading Style Sheet), client-side programming scripts, such as, JavaScript and VBScript, client-side databases, etc. Both the first computer-readable code and the second computer-readable code can support embedded objects, such as, audio and video elements, ActiveX controls, etc. Alternatively, the subscription may be enabled via other means, e.g., a desktop software or an application on a mobile device.

The Brand Owner 105 server computer can be running a variety of operating systems, such as, MICROSOFT WINDOWS, APPLE MAC OS X, UNIX, LINUX, GNU, BSD, FreeBSD, SUN SOLARIS, NOVELL NETWARE, OS/2, TPF, eCS (eComStation), VMS, Digital VMS, OpenVMS, AIX, z/OS, HP-UX, OS-400, etc. The web-based graphical user interface may be provided by a web-server software running on the Brand Owner 105 server computer. The web-server software may include MICROSOFT IIS (Internet Information Services/Server), APACHE HTTP SERVER, APACHE TOMCAT, nginx, GWS (GOOGLE WEB SERVER), SUN JAVA SYSTEM WEB SERVER, etc.

The Brand Owner 105 computer systems can contain one or more physical servers. The physical servers can play different roles in the system of the invention, e.g., a Web Server, a Mail Server, an Application Server, a Database Server, a DNS (Domain Name System) Server, etc. The Brand Owner 105 computer systems can be based on a variety of hardware platforms, such as, x86, x64, INTEL, ITANIUM, IA64, AMD, SUN SPARC, IBM, HP, etc.

The Subscribers 115 computer systems are electronic devices suitable for interaction over the Network 110. The Subscribers 115 computer systems may contain, for example, a personal computer, a desktop computer, a laptop computer, a notebook computer, a tablet computer, a cell phone, a smart phone, a PDA, a palmtop computer, a handheld computer, a pocket computer, a touch screen device, an IBM PC-compatible electronic device, an APPLE MAC-compatible electronic device, a computing device, a digital device, or another electronic device or combination thereof.

The Brand Owner 105, the Subscribers 115, and the Sources 120 are communicatively connected to the Network 110 via the Communication Links 125, 130, and 135. The Communication Links 125, 130, and 135 are wired or wireless connections suitable for exchange of digital information. The Communication Links 125, 130, and 135 may include telephone line, copper twisted pair, power-line, fiber-optic, cellular, satellite, dial-up, Ethernet, DSL, ISDN, T-1, DS-1, Wi-Fi, etc.

The Brand Owner 105 computer systems may be located in a physical datacenter, in a virtual datacenter, in a variety of countries or territories, on a floating device, be connected to the Internet backbone, be connected to a power grid, etc. The floating device may be a marine or naval vessel or ship. Brand Owner 105 computer systems may be cooled by air or liquid, such as water, including ocean or sea water.

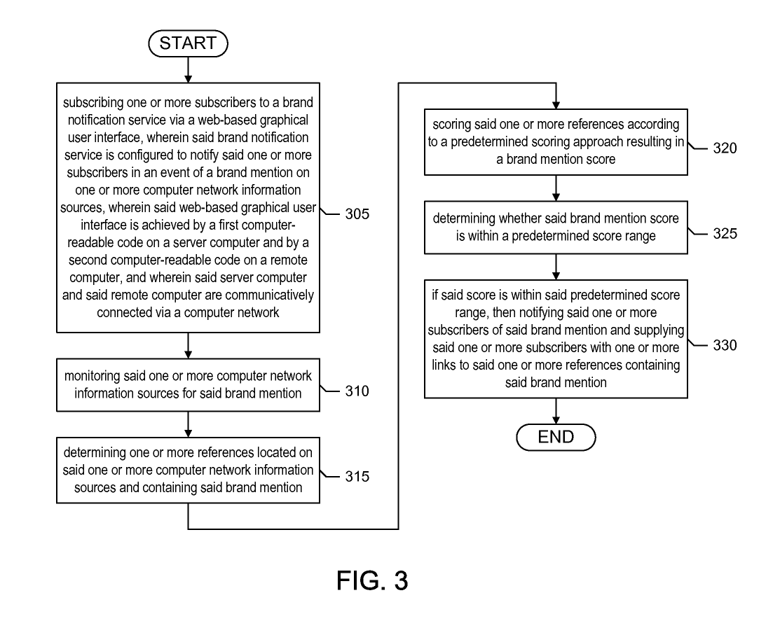

An exemplary embodiment of a method of present invention is shown in FIG. 3. The method comprises the steps of: subscribing one or more subscribers to a brand notification service via a web-based graphical user interface, where the brand notification service is configured to notify the one or more subscribers in an event of a brand mention on one or more computer network information sources, where the web-based graphical user interface is achieved by a first computer-readable code on a server computer and by a second computer-readable code on a remote computer, and where the server computer and the remote computer are communicatively connected via a computer network (step 305), monitoring the one or more computer network information sources for the brand mention (step 310), determining one or more references located on the one or more computer network information sources and containing the brand mention (step 315), scoring the one or more references according to a predetermined scoring approach resulting in a brand mention score (step 320), determining whether the brand mention score is within a predetermined score range (step 325), and if the score is within the predetermined score range, then notifying the one or more subscribers of the brand mention and supplying the one or more subscribers with one or more links to the one or more references containing the brand mention (step 330).

The brand notification service may be administered by a brand owner or third party providing such services.

The computer network information sources may include a website, a webpage, an online blog, a social network website, a product review website, a company review website, a commentary webpage, a feedback webpage, etc.

The particular references of where the brand mention is found may include a webpage on a website, an online post on a webpage, an online article, etc.

The monitoring of the one or more computer network information sources for the brand mention may contain monitoring those sources for mentioning of a name of a company, a name of a person, a trademark, a trade name, a service mark, a company's product, a company's service, a keyword, a key phrase, or any combination thereof.

The predetermined scoring approach may include for example identifying negative keywords (e.g., such as “sucks,” “fail,” “hate,” etc.) and generating the brand mention score as a function of a proximity of the negative keywords to the brand mention. The proximity may be measured in the number of characters, words, or paragraphs between the negative keywords and the brand mention. Some websites already provide scoring mechanisms for the reviewed products and services, thus the calculation of the brand mention score may be simplified.

The notification of the one or more subscribers of the brand mention may be implemented by transmitting an electronic mail message to the one or more subscribers, where the electronic mail message contains the one or more references containing the brand mention.

As an example, the brand mention score may take values of negative, neutral, and positive. In another example, it may accepts values from 1 to 5, where value 1 indicates most negative perception of a brand and value 5 indicates most positive perception of the brand. The predetermined score range in this case may be equal or less than 3. In another example, the brand mention score may accepts values accepts values of 0 and 1, where value 0 indicates positive perception of a brand (no action is needed) and value 1 indicates negative perception of the brand (action is needed). The predetermined score range in this case is 1.

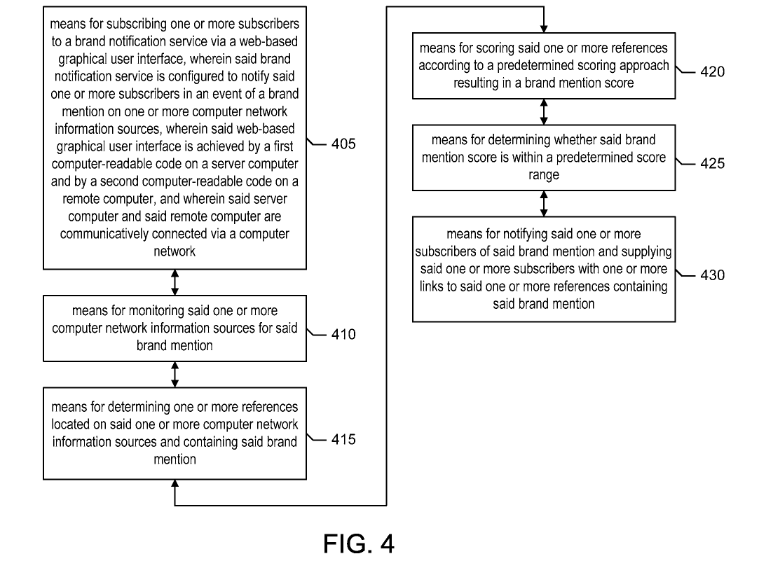

Referring to FIG. 4, an exemplary embodiment of the system of the present invention may include: means for subscribing one or more subscribers to a brand notification service via a web-based graphical user interface, where the brand notification service is configured to notify the one or more subscribers in an event of a brand mention on one or more computer network information sources, where the web-based graphical user interface is achieved by a first computer-readable code on a server computer and by a second computer-readable code on a remote computer, and where the server computer and the remote computer are communicatively connected via a computer network (405), means for monitoring the one or more computer network information sources for the brand mention (410), means for determining one or more references located on the one or more computer network information sources and containing the brand mention (415), means for scoring the one or more references according to a predetermined scoring approach resulting in a brand mention score (420), means for determining whether the brand mention score is within a predetermined score range (425), and means for notifying the one or more subscribers of the brand mention and supplying the one or more subscribers with one or more links to the one or more references containing the brand mention (430).

The brand notification service may be administered by a brand owner or third party providing such services.

The computer network information sources may include a website, a webpage, an online blog, a social network website, a product review website, a company review website, a commentary webpage, a feedback webpage, etc.

The particular references of where the brand mention is found may include a webpage on a website, an online post on a webpage, an online article, etc.

The means for monitoring the one or more computer network information sources for the brand mention may include means for monitoring those sources for mentioning of a name of a company, a name of a person, a trademark, a trade name, a service mark, a company's product, a company's service, a keyword, a key phrase, or any combination thereof

The predetermined scoring approach may include for example identifying negative keywords (e.g., such as “sucks,” “fail,” “hate,” etc.) and generating the brand mention score as a function of a proximity of the negative keywords to the brand mention. The proximity may be measured in the number of characters, words, or paragraphs between the negative keywords and the brand mention. Some websites already provide scoring mechanisms for the reviewed products and services, thus the calculation of the brand mention score may be simplified.

The means for notifying the one or more subscribers of the brand mention may comprise the means for transmitting an electronic mail message to the one or more subscribers, where the electronic mail message contains the one or more references containing the brand mention.

As an example, the brand mention score may take values of negative, neutral, and positive. In another example, it may accepts values from 1 to 5, where value 1 indicates most negative perception of a brand and value 5 indicates most positive perception of the brand. The predetermined score range in this case may be equal or less than 3. In another example, the brand mention score may accepts values accepts values of 0 and 1, where value 0 indicates positive perception of a brand (no action is needed) and value 1 indicates negative perception of the brand (action is needed). The predetermined score range in this case is 1.

The means of this embodiment can be substituted by machines, apparatuses, and devices described in this specification or equivalents thereof. As a non-limiting example, the means of this embodiment can be substituted on a computing device, a computer-readable code, a computer-executable code, or any combination thereof.

All embodiments of the present invention may further be limited and implemented with any and all limitations disclosed in this specification or in the documents incorporated in this patent application by reference.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

1. A system, comprising:
a) means for subscribing one or more subscribers to a brand notification service via a web-based graphical user interface, wherein said brand notification service is configured to notify said one or more subscribers in an event of a brand mention on one or more computer network information sources, wherein said web-based graphical user interface is achieved by a first computer-readable code on a server computer and by a second computer-readable code on a remote computer, and wherein said server computer and said remote computer are communicatively connected via a computer network,
b) means for monitoring said one or more computer network information sources for said brand mention,
c) means for determining one or more references located on said one or more computer network information sources and containing said brand mention,
d) means for scoring said one or more references according to a predetermined scoring approach resulting in a brand mention score,
e) means for determining whether said brand mention score is within a predetermined score range, and
f) means for notifying said one or more subscribers of said brand mention and supplying said one or more subscribers with one or more links to said one or more references containing said brand mention.

2. The system of claim 1, wherein said means for notifying said one or more subscribers of said brand mention comprises means for transmitting an electronic mail message to said one or more subscribers, wherein said electronic mail message contains said one or more references containing said brand mention.

3. The system of claim 1, wherein said means for monitoring said one or more computer network information sources for said brand mention comprises means for monitoring said one or more computer network information sources for mentioning of a name of a company.

4. The system of claim 1, wherein said means for monitoring said one or more computer network information sources for said brand mention comprises means for monitoring said one or more computer network information sources for mentioning of a name of a person.

5. The system of claim 1, wherein said means for monitoring said one or more computer network information sources for said brand mention comprises means for monitoring said one or more computer network information sources for mentioning of a trademark.

6. The system of claim 1, wherein said means for monitoring said one or more computer network information sources for said brand mention comprises means for monitoring said one or more computer network information sources for mentioning of a service mark.

7. The system of claim 1, wherein said means for monitoring said one or more computer network information sources for said brand mention comprises means for monitoring said one or more computer network information sources for mentioning of a company's product.

8. The system of claim 1, wherein said means for monitoring said one or more computer network information sources for said brand mention comprises means for monitoring said one or more computer network information sources for mentioning of a company's service.

9. The system of claim 1, wherein said means for monitoring said one or more computer network information sources for said brand mention comprises means for monitoring said one or more computer network information sources for mentioning of a keyword.

10. The system of claim 1, wherein said means for monitoring said one or more computer network information sources for said brand mention comprises means for monitoring said one or more computer network information sources for mentioning of a key phrase.

11. The system of claim 1, wherein said one or more computer network information sources comprises a website.

12. The system of claim 1, wherein said one or more computer network information sources comprises a webpage.

13. The system of claim 1, wherein said one or more computer network information sources comprises an online blog.

14. The system of claim 1, wherein said one or more computer network information sources comprises a social network website.

15. The system of claim 1, wherein said one or more computer network information sources comprises a product review website.

16. The system of claim 1, wherein said one or more computer network information sources comprises a company review website.

17. The system of claim 1, wherein said one or more computer network information sources comprises a commentary webpage.

18. The system of claim 1, wherein said one or more computer network information sources comprises a feedback webpage.

19. The system of claim 1, wherein said one or more references comprises a webpage on said one or more computer network information sources.

20. The system of claim 1, wherein said one or more references comprises an online post on said one or more computer network information sources.

21. The system of claim 1, wherein said one or more references comprises an online article on said one or more computer network information sources.

22. The system of claim 1, wherein said predetermined scoring approach comprises identifying one or more negative keywords and generating the brand mention score as a function of a proximity of said negative keywords to said brand mention.

23. The system of claim 1, wherein said brand mention score accepts values from 1 to 5, wherein value 1 indicates most negative perception of a brand and value 5 indicates most positive perception of said brand.

24. The system of claim 23, wherein said predetermined score range is equal or less than 3.

25. The system of claim 1, wherein said brand mention score accepts values of 0 and 1, wherein value 0 indicates positive perception of a brand and value 1 indicates negative perception of said brand.

26. The system of claim 25, wherein said predetermined score range is equal 1.
